(19) United States
(12) Patent Application Publication
(10) Pub. No.: US 2018/0299709 A1
(43) Pub. Date: Oct. 18, 2018

(54) CURVED DISPLAY APPARATUS AND METHOD FOR CONTROLLING CURVATURE THEREOF

(71) Applicants: HKC Corporation Limited, Shenzhen City, Guangdong (CN); Chongqing HKC Optoelectronics Technology Co., Ltd., Chongqing (CN)

(72) Inventor: Chia-Hang LEE, Chongqing (CN)

(21) Appl. No.: 15/555,761

(22) PCT Filed: Mar. 24, 2017
(86) PCT No.: PCT/CN2017/078127

§ 371 Date: Sep. 5, 2017

(30) Foreign Application Priority Data
Dec. 31, 2016 (CN) 201611268268.9

(51) Int. Cl. G02F 1/13; G02F 1/1333

(52) U.S. Cl. CPC G02F 1/1323; G02F 2001/133314; G02F 1/133308; G02F 1/133305

(57) ABSTRACT

This application relates to a curved display apparatus and a method for controlling a curvature thereof. The apparatus includes: a flexible display module; and a curvature adjustment module, coupled to the flexible display module and configured to adjust a curvature of the flexible display module. The curvature adjustment module includes: a gear control unit, including a gear; a primary rotation shaft and at least one secondary rotation shaft; two first curvature adjustment modules, pivotally coupled to the primary rotation shaft, to form a first movable bracket that moves correspondingly; and two second curvature adjustment modules, pivotally coupled to the secondary rotation shaft and meshed with the gear, to cooperate with the gear to control to form a second movable bracket that moves correspondingly. In this application, a curvature of the curved display apparatus is adjusted, so that a viewer can have better picture quality at a large viewing angle.

### BACKGROUND

### Technical Field

This application relates to a curved surface design method, and in particular, to a curved display apparatus and a method for controlling a curvature thereof.

### Related Art

Generally, as display technologies develop, appearances of display devices are also improved in addition to improvement in sizes and picture quality, for example, curved display devices come into existence. Compared with flat-screen display devices, curved display devices can not only have larger sizes while a width is the same, but also provide good viewing effects. Flat-screen televisions and curved televisions are used as an example. When a viewer moves eyes from the center of a screen of a flat-screen television to two external sides, the viewer usually finds that visual experience at the edge of the flat-screen television is poor. In particular, when traditional flat-screen liquid crystal display (both vertical alignment (VA) and in-plane switching (IPS)) televisions are viewed at a large viewing angle, there is generally a color difference from a central viewing angle. Consequently, picture quality becomes poorer as a viewing angle becomes larger. In contract, curved televisions have an annular design. Therefore, a picture distortion degree can be reduced at the edge of a screen, and visual on-site feeling is improved.

A traditional curved display device is manufactured by bending an entire substrate into an arc having a same curvature. However, in this production method, a peripheral circuit (for example, gate drive circuit) formed on a thin-film transistor array substrate is subject to a bending stress in a manufacturing process as the thin-film transistor array substrate is bent to form a curved surface. Consequently, properties of the circuit are affected. For example, because electron mobility deteriorates and a critical voltage increases, a circuit drive capability is damaged and circuit reliability becomes poorer. In other words, a curved display device has desirable viewing effects, but sacrifices original circuit performance. Therefore, a structure of an existing curved display device still needs to be improved.

### SUMMARY

To resolve the foregoing technical problem, this application aims to provide a curved surface design method, and in particular, a curved display apparatus and a method for controlling a curvature thereof. A gear control unit, a motor controller, and a signal processing chip generating a curvature control signal are combined to design a method for intelligently and automatically controlling a television curvature.

The following technical solutions are used to achieve the objective of this application and resolve the technical problem of this application. A curved display apparatus provided in this application comprises: a flexible display module; and a curvature adjustment module, coupled to the flexible display module, and configured to adjust a curvature of the flexible display module.

Alternatively, the following technical solutions are used to achieve the objective of this application and resolve the technical problem of this application.

A method for controlling a curvature of a curved display apparatus comprises: providing a flexible display module; and providing a curvature adjustment module, coupled to the flexible display module, and configured to adjust a curvature of the flexible display module.

In an embodiment of this application, the curvature adjustment module comprises: a gear control unit, comprising a gear; a primary rotation shaft and at least one secondary rotation shaft; two first curvature adjustment modules, pivotally coupled to the primary rotation shaft, to form a first movable bracket that moves correspondingly; and two second curvature adjustment modules, pivotally coupled to the secondary rotation shaft and meshed with the gear, to cooperate with the gear to control to form a second movable bracket that moves correspondingly.

In an embodiment of this application, the flexible display module comprises: a cover plate, comprising a first curved surface; and a backplane, disposed opposite to the cover plate and comprising a second curved surface.

In an embodiment of this application, the first curvature adjustment module is coupled to the backplane of the flexible display module, and the curvature of the flexible display module is adjusted by controlling rotation of the gear control unit.

In an embodiment of this application, the flexible display module further comprises a liquid crystal display panel, disposed between the backplane and the cover plate.

In an embodiment of this application, the gear control unit further comprises a motor controller connected to the gear, and the motor controller is a step motor.

In an embodiment of this application, the curved display apparatus further comprises: a curvature calculation unit, configured to sense an object to generate a curvature control signal to control the curvature adjustment module, to adjust the curvature of the flexible display module.

In an embodiment of this application, the first movable bracket and the second movable bracket are made of elastic aluminum alloy or a composite material thereof.

In an embodiment of this application, the curvature calculation unit may be a sensing chip or a sensor.

In embodiments of this application, according to the method, the step of adjusting the curvature of the flexible display module comprises: sensing, by a curvature calculation unit, an object to generate a curvature control signal; adjusting a rotation degree of a motor controller according to the curvature control signal; controlling a second movable bracket comprising two second curvature adjustment modules, and controlling a first movable bracket comprising two first curvature adjustment modules according to the rotation degree of the motor controller; coupling the first movable bracket to a backplane of the flexible display module, adjusting a second curved surface of the backplane by moving the first movable bracket; and adjusting a curvature of a first curved surface of the cover plate by adjusting a curvature of the second curved surface.

In this application, a curvature of the curved display apparatus is adjusted, so that a viewer can have better picture quality at a large viewing angle.

### BRIEF DESCRIPTION OF THE DRAWINGS

FIG. 1a is a schematic diagram of an exemplary television viewing angle;

FIG. 1b is a schematic diagram of an exemplary vertical color difference and an exemplary horizontal color difference;

FIG. 2a is a schematic diagram of an exemplary pixel gamma curve;

FIG. 2b is a schematic diagram of exemplarily controlling a pixel gamma curve by using a voltage;

FIG. 3 is an exemplary schematic diagram of a relationship between different viewing angles at which a user views a display and different distances between the user and the display;

FIG. 4 is another exemplary schematic diagram of a relationship between different viewing angles at which a user views a display and different distances between the user and the display;

FIG. 5 is a schematic diagram of a curved display apparatus according to an embodiment of this application; and

FIG. 6 is a flowchart of a method for controlling a curvature of a curved display apparatus according to an embodiment of this application.

### DETAILED DESCRIPTION

The following embodiments are described with reference to accompanying drawings, to provide examples of particular implementable embodiments of this application. Direction terms described in this application, for example, “above”, “below”, “front”, “behind”, “left”, “right”, “internal”, “external”, and “lateral face” indicate only directions with reference to accompanying drawings. Therefore, direction terms used are intended to describe and understand this application, instead of limiting this application.

Accompanying drawings and descriptions are considered as essentially illustrative instead of limitative. In drawings, units having similar structures are indicated by a same reference number. In addition, for ease of understanding and description, sizes and thicknesses of components shown in the accompanying drawings are randomly shown, but this application is not limited thereto.

In the accompanying drawings, for the purpose of clarity, thicknesses of layers, films, panels, areas, and the like are enlarged. In the accompanying drawings, for ease of understanding and description, thicknesses of layers and areas are enlarged. It should be understood that, when it is described that components such as layers, films, areas, or substrates are located “on” another component, the component may be directly located on the another component, or there may be a component therebetween.

In addition, in this specification, unless otherwise described clearly, the term “include” shall be understood as including a component, but not excluding any other components. In addition, in this specification, “on” means that a component is located above or below a target component, and does not mean that a component needs to be located on the top based on a gravity direction.

To further describe technical means used in this application to achieve a preset invention objective and technical effects of this application, the following describes, with reference to the accompanying drawings and preferred embodiments, in detail specific implementations, structures, features, and effects of a curved display apparatus and a method for controlling a curvature thereof provided based on this application.

The display device of this application includes a liquid crystal display panel and a backlight module, disposed opposite to each other. The liquid crystal display panel mainly includes a color filtering substrate, a thin film transistor substrate, and a liquid crystal layer sandwiched between the two substrates. The color filtering substrate, the thin film transistor substrate, and the liquid crystal layer may form a plurality of pixel units configured in arrays. The backlight module may emit light that penetrates through the liquid crystal display panel, and pixel units of the liquid crystal display panel display colors to form an image.

In an embodiment, the liquid crystal display panel of this application may be a curved display panel, and the display device of this application may also be a curved display apparatus.

A curved display is a display having a curved display surface. When a curved display is viewed, distances between eyes of a viewer and positions of the curved display are approximately equal. In addition, a viewer can view, at a viewing angle of approximately a right angle, images displayed in a central area and at left and right edges. Therefore, compared with a flat-screen display, a curved display does not have problems such as a luminance difference and a color difference when viewed at a large viewing angle. In addition, a curved display has a visual effect similar to stereoscopy. Therefore, curved displays have become display products that attract much attention. However, because curved displays are formed by bending flat-screen display panels under an external force, relative positions of two substrates may become erroneous. Consequently, a light leakage problem is caused and display quality of curved displays is affected.

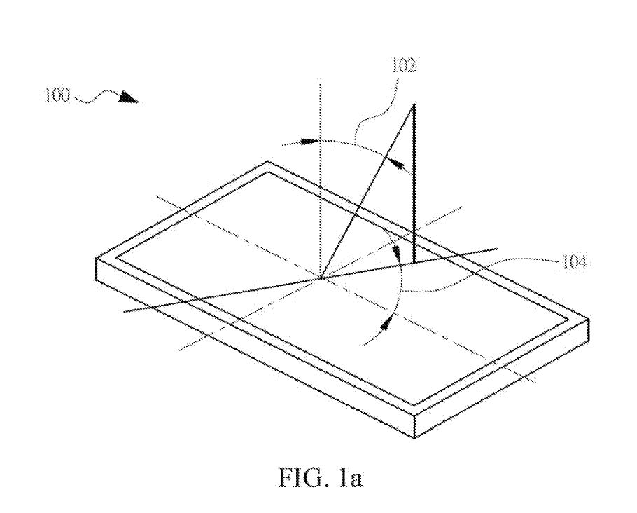

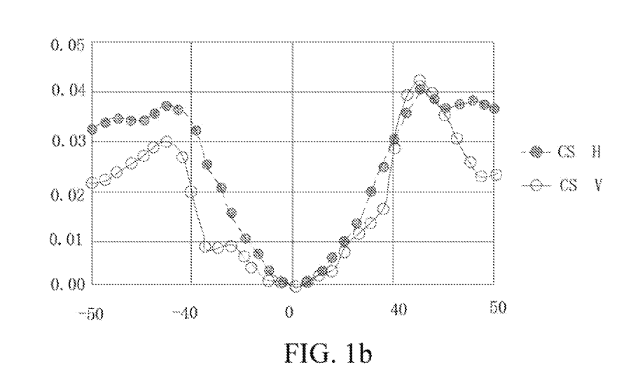

FIG. 1a is a schematic diagram of an exemplary television viewing angle. FIG. 1b is a schematic diagram of an exemplary vertical color difference and an exemplary horizontal color difference. Referring to FIG. 1a and FIG. 1b, currently, more televisions are designed by using curved surfaces. This is mainly because curved televisions have a novel appearance design. In addition, curved televisions have outstanding picture quality. In particular, when traditional flat-screen liquid crystal displays 100 such as both vertical alignment (VA) and in-plane switching (IPS) televisions are viewed at a large viewing angle, there is generally a horizontal color difference and a vertical color difference from a normal angle 102 of a central viewing angle and a horizontal angle 104 of the central viewing angle. As a result, picture quality becomes worse as a viewing angle becomes larger.

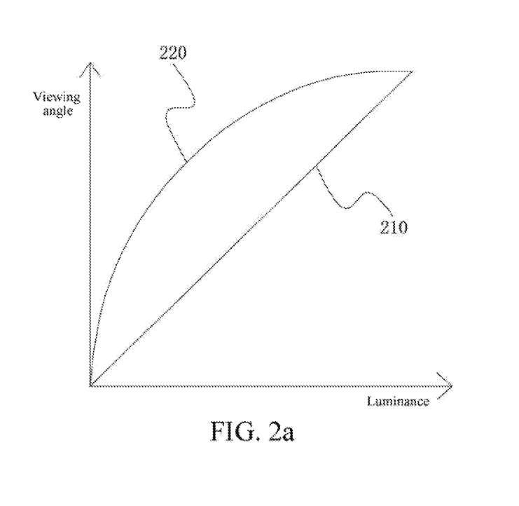

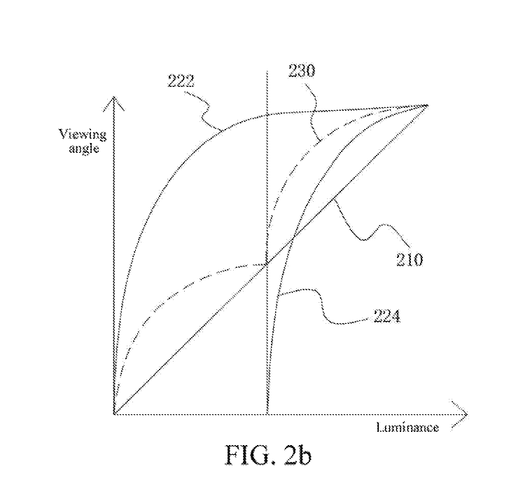

FIG. 2a is a schematic diagram of an exemplary pixel gamma curve. FIG. 2b is a schematic diagram of exemplarily controlling a pixel gamma curve by using a voltage. Referring to FIG. 2a and FIG. 2b, to improve a viewing angle of traditional flat-screen liquid crystal displays, one pixel is divided into two subpixels, that is, a subpixel A and a subpixel B, a gamma curve 222 of the subpixel A and a gamma curve 224 of the subpixel B are controlled by using a voltage, and the gamma curve 222 of the subpixel A and the gamma curve 224 of the subpixel B are combined into a gamma curve 230 different from a traditional gamma curve 220 and close to an ideal gamma curve 210, to offset and alleviate a color difference of a lateral viewing angle. This method is referred to as a spatial pixel offset method.

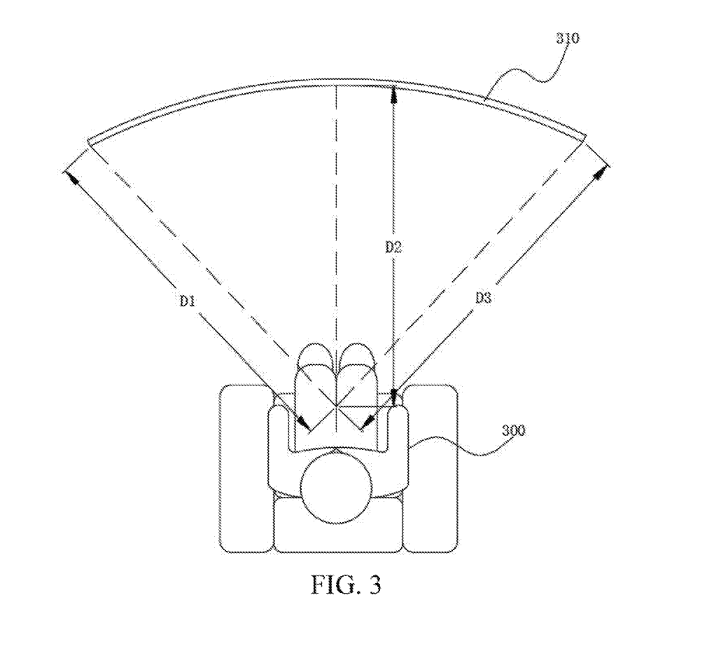

FIG. 3 is an exemplary schematic diagram of a relationship between different viewing angles at which a user 300 views a display 310 and different distances between the user and the display 310. Referring to FIG. 3, when a user views a flat-screen display, a distance from the center of an image displayed by the flat-screen display to the user is not equal to distances from two sides of the displayed image to the user. As a result, an image seen by the user is distorted. Therefore, a curved display 310 is proposed. When a user 300 views the curved display 310, because the distance from the center of an image displayed by the curved display 310 to the user 300 is close to distances from two sides of the image displayed by the curved display 310 to the user, the user 300 can see an image that can simulate reality to a higher degree and feel less tired. Therefore, another method for improving picture quality of a viewing angle is a design method using a curved display. That is, corresponding display curvatures are calculated for specified viewing distances D1, D2, and D3. A display curvature is generally around R2000, and a television curvature is designed to be around R4000. Referring to the schematic diagram of FIG. 3, it can be seen that when proper curvatures and proper viewing distances D1, D2, and D3 are provided, various viewing angles of the display 310 are consistent with a central front viewing angle of the display 310, to resolve picture quality degradation of a screen caused by different viewing angles.

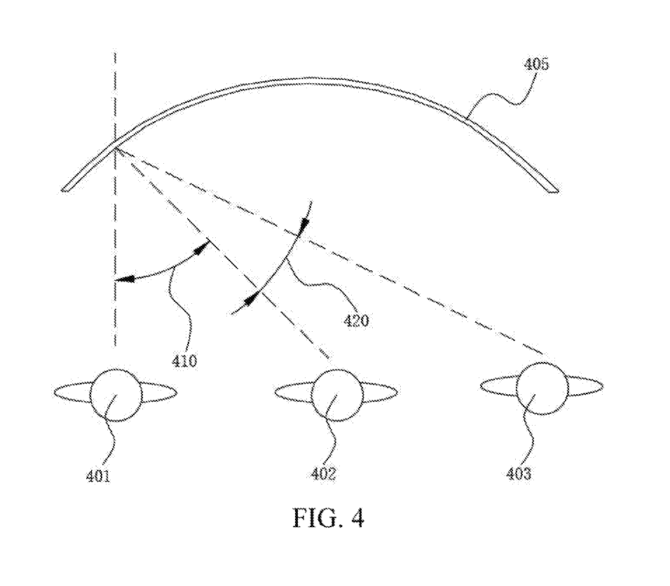

FIG. 4 is another exemplary schematic diagram of a relationship between different viewing angles at which users 401, 402, and 403 view a display 405 and different distances between the users and the display 405. Referring to FIG. 4, traditionally, a curved display 405 is designed for one viewer 402 at an on-axis coordinate location (that is, a central location). However, generally a television 405 may be viewed by more than one viewer 401, 402, and 403, and may not be viewed at a central location. Therefore, despite a condition of optimal viewing angles 410 and 420 of the curved television 405, optimal picture quality cannot be obtained because of different locations of the viewers 401, 402, and 403.

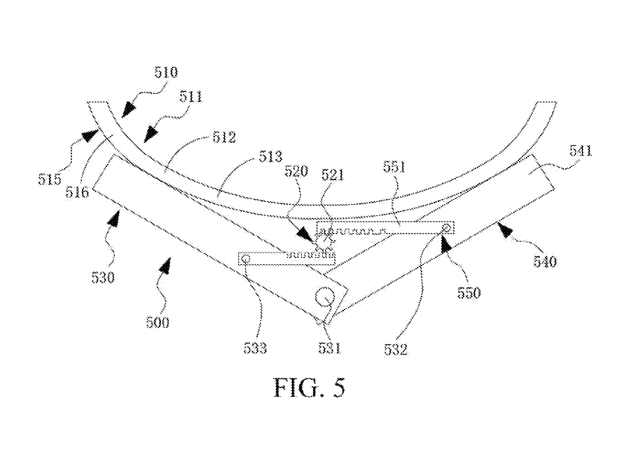

FIG. 5 is a schematic diagram of a curved display apparatus 500 according to an embodiment of this application. Referring to FIG. 5, in an embodiment of this application, a curved display apparatus 500 includes: a flexible display module 510, a curvature adjustment module 530, and a curvature calculation unit (not shown in FIG. 5). The flexible display module 510 includes: a cover plate 511, including a first curved surface 512; a backplane 515, disposed opposite to the cover plate 511 and including a second curved surface 516; and a liquid crystal display panel 513, disposed between the backplane 515 and the cover plate 511. The curvature adjustment module 530 is coupled to the flexible display module 510, and configured to adjust a curvature of the flexible display module 510. The curvature adjustment module 530 includes: a gear control unit 520, including a gear 521; a primary rotation shaft 531 and at least one secondary rotation shaft 532 and 533; two first curvature adjustment modules 540, pivotally coupled to the primary rotation shaft 531, to form a first movable bracket 541 that moves correspondingly; and two second curvature adjustment modules 550, pivotally coupled to the secondary rotation shafts 532 and 533 and meshed with the gear 521, to cooperate with the gear 521 to control to form a second movable bracket 551 that moves correspondingly. The curvature calculation unit is configured to sense an object to generate a curvature control signal to control the curvature adjustment module 530, to adjust the curvature of the flexible display module 510.

In an embodiment, the gear control unit 520 in this application further includes a motor controller, connected to the gear 521.

In an embodiment, the motor controller in this application is a step motor.

In an embodiment of this application, the first movable bracket and the second movable bracket are made of elastic aluminum alloy or a composite material thereof.

In an embodiment, the curvature calculation unit in this application may be a sensing chip or a sensor.

In an embodiment, in this application, the first curvature adjustment module 540 is coupled to the backplane 515 of the flexible display module 510, and the curvature of the flexible display module 510 is adjusted by controlling rotation of the gear control unit 520.

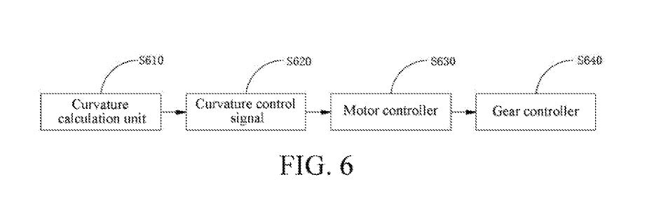

FIG. 6 is a flowchart of a method for controlling a curvature of a curved display apparatus 500 according to an embodiment of this application. Referring to FIG. 5 and FIG. 6, in an embodiment of this application, a method for controlling a curvature of a curved display apparatus 500 includes: providing a flexible display module 510; and providing a curvature adjustment module 530, coupled to the flexible display module 510, and configured to adjust a curvature of the flexible display module 510.

In an embodiment, according to the method in this application, the step of adjusting a curvature of a flexible display module 510 includes: sensing, by a curvature calculation unit (not shown in FIG. 6) S610, an object to generate a curvature control signal; adjusting a rotation degree of a motor controller S630 according to the curvature control signal S620; controlling a second movable bracket 551 including two second curvature adjustment modules 550, and controlling a first movable bracket 541 including two first curvature adjustment modules 540 according to the rotation degree of the motor controller, that is, a rotation degree of a gear controller S640; coupling the first movable bracket 541 to a backplane 515 of the flexible display module 510, and adjusting a second curved surface 516 of the backplane 515 by moving the first movable bracket 541; and adjusting a curvature of a first curved surface 512 of the cover plate 511 by adjusting a curvature of the second curved surface 516.

In an embodiment, in the method of this application, the motor controller is a step motor.

In an embodiment, in the method of this application, the curvature calculation unit may be a sensing chip or a sensor.

In this application, a curvature of the curved display apparatus is adjusted, so that a viewer can have better picture quality at a large viewing angle.

Phrases such as “in some embodiments” and “in various embodiments” are repeatedly used. The phrases generally do not indicate same embodiments, but may also indicate same embodiments. Unless otherwise described in context, terms such as “include”, “have”, and “comprise” are synonyms.

Only preferred embodiments of the present invention are provided above, and are not intended to limit this application in any form. Although preferred embodiments of this application are disclosed above, the preferred embodiments of this application are not intended to limit this application. Any person skilled in the art may change or embellish the technical content disclosed above to obtain equivalent embodiments without departing from the scope of the technical solutions of this application. Therefore, any simple modification, equivalent change, and embellishment made on the foregoing embodiments according to the technical essence of this application without departing from the content of the technical solutions of this application shall fall within the scope of the technical solutions of this application.

What is claimed is:

1. A curved display apparatus, comprising:
a flexible display module; and
a curvature adjustment module, coupled to the flexible display module, and configured to adjust a curvature of the flexible display module.

2. The curved display apparatus according to claim 1, wherein the curvature adjustment module comprises:
a gear control unit, comprising a gear;
a primary rotation shaft and at least one secondary rotation shaft;
two first curvature adjustment modules, pivotally coupled to the primary rotation shaft, to form a first movable bracket that moves correspondingly; and
two second curvature adjustment modules, pivotally coupled to the secondary rotation shaft and meshed with the gear, to cooperate with the gear to control to form a second movable bracket that moves correspondingly.

3. The curved display apparatus according to claim 1, wherein the flexible display module comprises: a cover plate, comprising a first curved surface; and a backplane, disposed opposite to the cover plate and comprising a second curved surface.

4. The curved display apparatus according to claim 3, wherein the first curvature adjustment module is coupled to the backplane of the flexible display module, and the curvature of the flexible display module is adjusted by controlling rotation of the gear control unit.

5. The curved display apparatus according to claim 3, wherein the flexible display module further comprises a liquid crystal display panel, disposed between the backplane and the cover plate.

6. The curved display apparatus according to claim 2, wherein the gear control unit further comprises a motor controller connected to the gear, and the motor controller is a step motor.

7. The curved display apparatus according to claim 1, further comprising: a curvature calculation unit, configured to sense an object to generate a curvature control signal to control the curvature adjustment module, to adjust the curvature of the flexible display module

8. The curved display apparatus according to claim 7, wherein the curvature calculation unit is a sensing chip.

9. The curved display apparatus according to claim 7, wherein the curvature calculation unit is a sensor.

10. A method for controlling a curvature of a curved display apparatus, comprising:
providing a flexible display module; and
providing a curvature adjustment module, coupled to the flexible display module, and configured to adjust a curvature of the flexible display module.

11. The method for controlling a curvature of a curved display apparatus according to claim 10, wherein the step of adjusting a curvature of the flexible display module comprises:
sensing an object to generate a curvature control signal according to a curvature calculation unit;
adjusting a rotation degree of a motor controller according to the curvature control signal;
controlling a second movable bracket comprising two second curvature adjustment modules, and controlling a first movable bracket comprising two first curvature adjustment modules according to the rotation degree of the motor controller;
coupling the first movable bracket to a backplane of the flexible display module, and adjusting a second curved surface of the backplane by moving the first movable bracket; and
adjusting a curvature of a first curved surface of the cover plate by adjusting a curvature of the second curved surface.

12. The method for controlling a curvature of a curved display apparatus according to claim 10, wherein the curvature adjustment module comprises:
a gear control unit, comprising a gear;
a primary rotation shaft and at least one secondary rotation shaft;
two first curvature adjustment modules, pivotally coupled to the primary rotation shaft, to form a first movable bracket that moves correspondingly; and
two second curvature adjustment modules, pivotally coupled to the secondary rotation shaft and meshed with the gear, to cooperate with the gear to control to form a second movable bracket that moves correspondingly.

13. The method for controlling a curvature of a curved display apparatus according to claim 10, wherein the flexible display module comprises: a cover plate, comprising a first curved surface; and a backplane, disposed opposite to the cover plate and comprising a second curved surface.

14. The method for controlling a curvature of a curved display apparatus according to claim 13, wherein the first curvature adjustment module is coupled to the backplane of the flexible display module, and the curvature of the flexible display module is adjusted by controlling rotation of the gear control unit.

15. The method for controlling a curvature of a curved display apparatus according to claim 13, wherein the flexible display module further comprises a liquid crystal display panel, disposed between the backplane and the cover plate.

16. The method for controlling a curvature of a curved display apparatus according to claim 12, wherein the gear control unit further comprises a motor controller connected to the gear, and the motor controller is a step motor.

17. The method for controlling a curvature of a curved display apparatus according to claim 11, wherein the curvature calculation unit is configured to sense an object to generate a curvature control signal to control the curvature adjustment module, to adjust the curvature of the flexible display module.

18. The method for controlling a curvature of a curved display apparatus according to claim 17, wherein the curvature calculation unit is a sensing chip.

19. The method for controlling a curvature of a curved display apparatus according to claim 17, wherein the curvature calculation unit is a sensor.

20. A curved display apparatus, comprising:
a flexible display module;
a curvature adjustment module, coupled to the flexible display module, and configured to adjust a curvature of the flexible display module; and
a curvature calculation unit, configured to sense an object to generate a curvature control signal to control the curvature adjustment module, to adjust the curvature of the flexible display module, wherein
the curvature adjustment module comprises: a gear control unit, comprising a gear; a primary rotation shaft and at least one secondary rotation shaft; two first curvature adjustment modules, pivotally coupled to the primary rotation shaft, to form a first movable bracket that moves correspondingly; and two second curvature adjustment modules, pivotally coupled to the secondary rotation shaft and meshed with the gear, to cooperate with the gear to control to form a second movable bracket that moves correspondingly;
the flexible display module comprises: a cover plate, comprising a first curved surface; and a backplane, disposed opposite to the cover plate and comprising a second curved surface; and
the first movable bracket and the second movable bracket are made of elastic aluminum alloy or a composite material thereof.
